(19) United States
(12) Patent Application Publication
(10) Pub. No.: US 2021/0368468 A1
(43) Pub. Date: Nov. 25, 2021

(54) POSITIONING AND MEASUREMENT REPORTING METHOD AND APPARATUS

(71) Applicant: China Academy of Telecommunications Technology, Beijing (CN)

(72) Inventors: Yanping XING, Beijing (CN); Ren DA, Beijing (CN); Haiyang QUAN, Beijing (CN)

(73) Assignee: China Academy of Telecommunications Technology, Beijing (CN)

(21) Appl. No.: 16/634,299

(22) PCT Filed: Aug. 1, 2018
(86) PCT No.: PCT/CN2018/098165

§ 371 Date: Jan. 27, 2020

(30) Foreign Application Priority Data
Aug. 9, 2017 (CN) 201710676429.6

(51) Int. Cl. H04W 64/00; H04W 24/10

(52) U.S. Cl. CPC H04W 64/00; H04W 24/10

(57) ABSTRACT

Disclosed are a positioning and measurement reporting method and apparatus, used for implementing a solution regarding UE positioning in a 5G NR system. The present application provides a positioning method, comprising: determining a measurement configuration message of a user equipment (UE), the measurement configuration message comprising UE-level measurement reference signal configuration information; sending the measurement configuration message to the UE to instruct the UE to report the measurement; and positioning the UE on the basis of the measurement result reported by the UE.

The present application claims the priority from Chinese Patent Application No. 201710676429.6, filed with the Chinese Patent Office on Aug. 9, 2017 and entitled “Positioning and Measurement Reporting Method and Apparatus”, which is hereby incorporated by reference in its entirety.

### FIELD

The present application relates to the field of communication technologies and particularly to a positioning and measurement reporting method and apparatus.

### BACKGROUND

The Next generation Radio (NR) system of the 5th Generation (5G) mobile communication system defines the following four downlink reference signals:

1. NR Synchronization Signal Block (SS Block):

In the 5G NR system, the downlink reference signals in the SS block include: Primary Synchronization Signal (PSS), Secondary Synchronization Signal (SSS), and DeModulation Reference Signal (DM-RS) for the Physical Broadcast CHannel (PBCH).

One SS burst contains a plurality of SS blocks, and one SS burst set includes a plurality of SS bursts.

The maximum number of the SS blocks which can be included in one SS burst set is determined by the carrier frequency. Specifically, for the carrier frequencies less than 3 GHz, one SS burst set may include at most 4 SS blocks; for the carrier frequencies of 3 GHz-6 GHz, one SS burst set may include at most 8 SS blocks; for the carrier frequencies greater than 6 GHz, one SS burst set may include at most 64 SS blocks. The SS burst set may be sent in cycle of {5, 10, 20, 40, 80, 160} ms. The transmission of all the SS blocks in one SS burst set is completed in the window of 5 ms. The optional positions for transmitting the SS blocks during the transmission period of 5 ms are specified in the protocol.

To enhance the coverage, the beam scanning is supported, that is, the SS blocks are transmitted by different beams at different times. Thus, different users may detect the PSS/SSS at different symbol positions, so there is a need to further indicate the time index of the SS block.

2. Reference Signal Received Power of SS Blocks (SS-RSRP):

The NR system supports the User Equipment (UE) to perform the SS-RSRP measurement. The SS-RSRP is determined according to the measurement result of the secondary synchronization signal. The UE may further additionally use the DM-RS of the PBCH to assist in determining the RSRP.

3. Channel State Information-Reference Signal (CSI-RS):

For the purpose of beam management and Radio Resource Management (RRM) and others, the 5G NR system supports the UE-specialized CSI-RS.

4. Reference Signal Received Power of Channel State Information (CSI-RSRP):

The NR system supports the UE to perform the CSI-RSRP measurement. The UE obtains the CSI-RSRP by measuring the Resource Element (RE) bearing the CSI-RS.

However, no UE positioning scheme has been introduced for the 5G NR system at present.

### SUMMARY

The embodiments of the present application provides a positioning and measurement reporting method and apparatus, to implement the UE positioning scheme of the 5G NR system.

At the network side, a positioning method provided by an embodiment of the present application includes:

determining a measurement configuration message of a User Equipment, UE, where the measurement configuration message includes UE-level measurement reference signal configuration information;

sending the measurement configuration message to the UE to instruct the UE to perform measurement and reporting;

positioning the UE based on a measurement result reported by the UE.

With this method, the measurement configuration message of the UE is determined, where the measurement configuration message includes the UE-level measurement reference signal configuration information; the measurement configuration message is sent to the UE to instruct the UE to perform the measurement and reporting; and the UE is positioned based on the measurement result reported by the UE, thereby implementing the UE positioning scheme based on the reference signal defined by the 5G NR system.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index; and

Time Difference of Arrival, TDOA, of CSI-RS s.

Optionally, the measurement configuration message and/or the measurement result is/are transmitted by a radio resource control protocol message or 5G positioning protocol message.

Accordingly, at the UE side, a measurement reporting method provided by an embodiment of the present application includes:

obtaining a measurement configuration message of a User Equipment, UE, where the measurement configuration message includes UE-level measurement reference signal configuration information;

performing a measurement according to the measurement configuration message and reporting a measurement result.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

Corresponding to the above-mentioned methods, the embodiments of the present application further provide the following apparatuses.

At the network side, a positioning apparatus provided by an embodiment of the present application includes:

a determining unit configured to determine a measurement configuration message of a User Equipment, UE, where the measurement configuration message includes UE-level measurement reference signal configuration information;

a sending unit configured to send the measurement configuration message to the UE to instruct the UE to perform measurement and reporting;

a measurement result processing unit configured to position the UE based on a measurement result reported by the UE.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index; and

Time Difference of Arrival, TDOA, of CSI-RSs.

Optionally, the measurement configuration message and/or the measurement result is/are transmitted by a radio resource control protocol message or 5G positioning protocol message.

At the UE side, a measurement reporting apparatus provided by an embodiment of the present application includes:

an obtaining unit configured to obtain a measurement configuration message of a User Equipment, UE, where the measurement configuration message includes UE-level measurement reference signal configuration information;

a reporting unit configured to perform measurement according to the measurement configuration message and report a measurement result.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index; and

Time Difference of Arrival, TDOA, of CSI-RSs.

Optionally, the measurement configuration message and/or the measurement result is/are transmitted by a radio resource control protocol message or 5G positioning protocol message.

### BRIEF DESCRIPTION OF THE DRAWINGS

In order to illustrate the technical solutions in the embodiments of the present application more clearly, the accompanying figures which need to be used in describing the embodiments will be introduced below briefly. Obviously the accompanying figures described below are only some embodiments of the present application, and other accompanying figures can also be obtained by those ordinary skilled in the art according to these accompanying figures without creative labor.

FIG. 1 is a schematic diagram of 64 positions available for one SS block burst set when the carrier frequency is greater than 6 GHz provided by an embodiment of the present application;

FIG. 2 is a schematic diagram illustrating the allocation of different SS block positions for different cells in one SS block burst set provided by an embodiment of the present application;

FIG. 3 is a schematic diagram of the information of the SS blocks that the terminal UE can detect notified by the network side in advance provided by an embodiment of the present application;

FIG. 4 is a flow schematic diagram of a positioning method at the network side provided by an embodiment of the present application;

FIG. 5 is a flow schematic diagram of a measurement reporting method at the UE side provided by an embodiment of the present application;

FIG. 6 is a flow schematic diagram of positioning through the RRC protocol provided by an embodiment of the present application;

FIG. 7 is a flow schematic diagram of positioning through the LPP protocol provided by an embodiment of the present application;

FIG. 8 is a structural schematic diagram of a positioning apparatus at the network side provided by an embodiment of the present application;

FIG. 9 is a structural schematic diagram of a measurement reporting apparatus at the UE side provided by an embodiment of the present application;

FIG. 10 is a structural schematic diagram of a positioning apparatus at the network side provided by an embodiment of the present application;

FIG. 11 is a structural schematic diagram of a measurement reporting apparatus at the UE side provided by an embodiment of the present application.

### DETAILED DESCRIPTION OF THE EMBODIMENTS

In order to make the purposes, technical solutions and advantages of the invention clearer, the technical solutions in the embodiments of the invention will be described clearly and completely below in combination with the accompanying drawings in the embodiments of the invention. Obviously the described embodiments are a part of the embodiments of the invention but not all the embodiments. Based upon the embodiments of the invention, all of other embodiments obtained by those ordinary skilled in the art without creative work pertain to the protection scope of the invention.

It should be understood that the technical solutions of the invention can be applied to various communication systems, for example, Global System of Mobile communication (GSM) system, Code Division Multiple Access (CDMA) system, Wideband Code Division Multiple Access (WCDMA) system, General Packet Radio Service (GPRS), Long Term Evolution (LTE) system, Advanced long term evolution (LTE-A) system, Universal Mobile Telecommunication System (UMTS), New Radio (NR) and the like.

It should be further understood that the User Equipment (UE) includes but not limited to a Mobile Station (MS), a mobile terminal, a mobile telephone, a handset, a portable equipment or the like in the embodiments of the invention. This user equipment can communicate with one or more core networks via the Radio Access Network (RAN), for example, the user equipment can be a mobile telephone (or called “cellular” telephone), a computer with the wireless communication function, or the like. The user equipment can also be a portable, pocket, handheld, computer built-in or vehicle-carried mobile device.

In the embodiments of the invention, the base station (e.g., access point) can mean the device in the access network communicating with the wireless terminal via one or more sectors over the air interface. The base station can be used to perform the inter-conversion between the received air frame and the IP packet, and used as the router between the wireless terminal and the rest of the access network, where the rest of the access network may include Internet Protocol (IP) networks. The base station can further coordinate the attribute management of the air interface. For example, the base station can be the Base Transceiver Station (BTS) in the GSM or CDMA, or can be the NodeB in the TD-SCDMA or WCDMA, or can be the evolutional Node B (eNodeB or eNB or e-NodeB) in the LTE, or can be the gNB in the 5G NR, which is not limited in the invention.

The embodiments of the present application provides a positioning and measurement reporting method and apparatus, so as to implement the UE positioning scheme of the 5G NR system.

The technical solution provided by the embodiments of the present application uses the downlink reference signal in the 5G NR system to support the terminal positioning in the 5G NR system, and the specific introduction is as follows.

The terminal UE obtains the UE-level measurement configuration message from the network side, where the measurement configuration message contains the UE-level measurement reference signal configuration information. UE performs the measurement based on the measurement configuration message and reports the measurement result, and the network-side device positions the UE according to the measurement result.

Here the measurement configuration message may specifically includes the SS block configuration message or CSI-RS configuration message.

The SS block configuration message includes the SS block configuration message of the neighboring cells (non-serving cells).

When the measurement configuration message specifically includes the SS block configuration message, the measurement result reported by UE includes: SS-RSRP and/or Time Difference of Arrival of SS Blocks (SS-TDOA), and may further include: the cell identity and/or SS block time index, corresponding to the SS-RSRP; where the SS-TDOA refers to the relative time difference between the SS block signals of two cells received at the terminal side.

When the measurement configuration message specifically includes the CSI-RS configuration message, UE reports the CSI-RSRP and CSI-RS index, and/or CSI-RS TDOA measurement result. Here, the CSI-RS TDOA refers to the relative time difference between the CSI-RS signals of two cells received at the terminal side.

The measurement configuration message and/or the measurement result is/are transmitted by the Radio Resource Control (RRC) protocol or 5G positioning protocol message.

The illustration of two specific embodiments will be presented below.

First embodiment: when the positioning is performed based on the downlink reference signal in the SS block, the specific flow includes the following steps.

Step 1: the terminal obtains the configuration information of the SS blocks of the serving cell and/or neighboring cells from the network side.

In order to measure the downlink reference signal in the SS block, the network side needs to notify the UE of the configuration information of the SS block including the time-frequency resource configuration of the SS block.

The detection performance of the reference signal in the SS block depends on the signal strength and interference level. In order to support the use of the reference signal in the SS block for UE positioning, the network-side device should properly configure the sending of the SS blocks of the serving cell and the neighboring cells to support the UE positioning. Specifically, the network-side device may design and adjust the transmission directions of the SS blocks and/or use the SS block muting to avoid or reduce the mutual interference of the SS blocks from the neighboring cells and improve the detection performance of the reference signals in the SS block.

The appropriate adjustment of the transmission directions of the SS block may avoid the spatial overlapping of the SS block signals, reduce the interference caused by the mutual overlapping of the SS block transmissions of multiple cells, and improve the detection performance of the SS block. For example, if the SS blocks of two neighboring cells are transmitted simultaneously at the same time but the transmission beam directions are opposite, the SS block signals from the two neighboring cells may not interfere with each other. How to adjust the transmission directions of the SS blocks of the neighboring cells to thereby effectively eliminate the overlap between the SS block signals may be implemented depending on the network.

For the synchronized NR system, candidate SS block transmission positions overlap in time. In order to improve the detection performance of the SS blocks of the neighboring cells, e.g., minimize the interference, the sending of the partial SS blocks may be closed, e.g., by using the SS block muting patterns (silent mode), to avoid the overlapping of the SS block transmission positions in time. The design of the SS block muting pattern may be diverse. A simplest and most direct way is to use ‘0’ to represent the position where no SS block is transmitted and ‘1’ to represent the position where the SS block is actually transmitted.

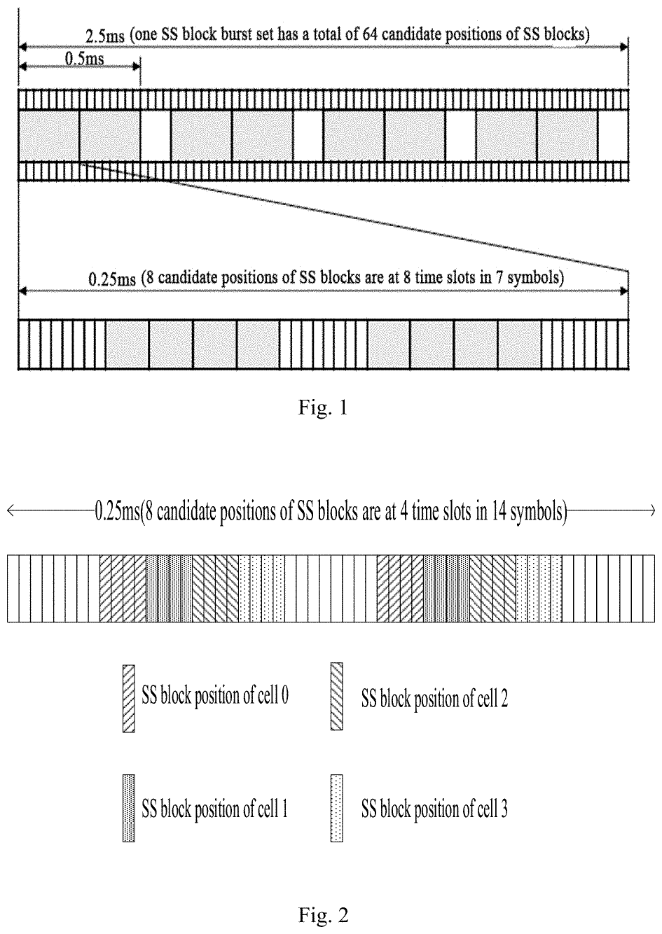

For example, FIG. 1 shows there are 64 candidate SS block transmission positions tⱼ (j=0, . . . , 63) in one SS block burst set.

Referring to FIG. 2, it is assumed that the serving cell of the UE is C₀, and has three neighboring cells {C₁, C₂, C₃}. The network-side device may configure the 64-bits muting patterns for the cell Cᵢ (i=0, 1, 2, 3) by setting positions tᵢ₊₄ₖ=1 (k=0, . . . 15) and setting other bits as 0, which means that the SS blocks are transmitted only at the candidate positions of tᵢ₊₄ₖ (k=0, . . . 15) for the cell Cᵢ (i=0, 1, 2, 3). In such way, the network avoid the interference caused by the mutual overlapping of the SS block transmissions of multiple cells, increase the signal to noise ratio, and facilitate the UE to detect the SS blocks from these cells.

In order to support the NR UE positioning, the network needs to notify the UE of the muting SS blocks or the SS blocks which are actually sent from the serving cell and/or neighboring cells, to help the UE to measure the SS blocks at the configured period.

According to the approximate position of the UE and the propagation direction of the neighboring cells, the network side may further inform the UE of the cells under which the SS blocks are most likely to be detected by the UE.

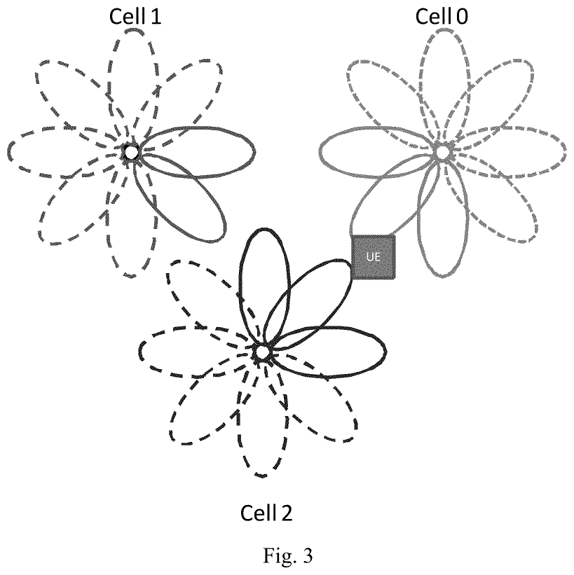

For the UE in the connected state, the network may know the approximate position of the UE according to the direction of the service beam as well as the time difference between reception and transmission Rx-Tx of the UE (UE Rx-Tx Time Difference) and other information. Then the network may reckon the neighboring cells of which the SS blocks may be detected by the UE according to the approximate position of the UE and the SS block transmission of the neighboring cells, for example, the SS block represented by the solid line in FIG. 3. The network may inform the UE of the information about these SS blocks in advance. The information will facilitate the UE to detect these SS blocks quickly to support the NR UE positioning.

Step 2: the terminal side measures the SS-RSRP of the serving cell and/or neighboring cells according to the configuration information; and measures the SS-TDOA between different cells.

According to the SS block configuration information of the serving cell and neighboring cells, the UE may obtain the measurement result of the signal power (i.e., SS-RSRP of the serving cell and neighboring cells) by detecting the reference signal in the SS block.

Furthermore, the SS block is transmitted at the predefined OFDM symbol position (i.e., predefined time). When a UE detects the SS block of a cell, the UE may estimate the arrival time of the SS block after it is sent from the cell. If the UE detects the SS blocks of more than one cell, the UE may measure the Time Difference of Arrival of SS Blocks (SS-TDOA) of the reference signals from different cells. Specifically, the measurement may be performed according to the secondary synchronization signals in the SS blocks, and the DM-RS of the PBCH may further additionally used to assist in determining the SS-TDOA.

Step 3: the terminal reports the measurement result of the SS-RSRP and/or SS-TDOA, and the corresponding cell identity and SS block time index.

In order to support the NR UE positioning, the network may configure the UE to report the SS-RSRP or SS-TDOA, or report them at the same time. When the measurement result of the SS-RSRP is reported, the corresponding cell ID and SS block index should be reported at the same time. Here, the SS block index information contributes to the determination of the direction of the UE with respect to the cell position, since the transmission directions of the various SS blocks are different.

Second embodiment: when the positioning is performed by using the CSI-RS, the specific flow includes the following steps.

Step 1: the terminal obtains the configuration information of the CSI-RS of the serving cell and/or neighboring cells from the network side.

The network needs to notify the terminal of the transmission configuration of the CSI-RS, including the time-frequency position of the CSI-RS.

If the network configures the CSI-RS for supporting the data communication (for example, CSI-RS for beam management and/or RRM measurement) for a UE, the network may reuse this CSI-RS to support the NR UE positioning.

The capability of detecting the CSI-RS may be enhanced by coordinating the CSI-RS transmissions of the respective cells. A solution is to configure the same or overlapping CSI-RS resources for the CSI-RS transmissions of the neighboring cells to avoid the interference from the data transmission. After such configuration, the interference from the neighboring cells may be estimated and eliminated through the known CSI-RS resource configuration, thereby enhancing the capability of detecting the CSI-RS. On this basis, and similarly to the muting design idea of the SS block, the sending power of the CSI-RS on some overlapping CSI-RS resources of some cells may also be set as 0. This method eliminates the interference from the CSI-RS transmissions of some neighboring cells, thus further enhancing the capability of detecting the CSI-RS from other neighboring cells. The CSI-RS is also highly dependent on the beam direction. The CSI-RS transmissions from two cells with the overlapping time-frequency resources will not interfere with each other if their beam directions do not overlap. Thus, it is not necessary to set the sending power of the CSI-RS of the neighboring cells with the overlapping time-frequency resources but with non-overlapping beam directions as 0. In such way, the network reduces the interference of the signals with each other according to the overlapping characteristics of the signals in time-frequency/beam direction.

For the UE in the connected state, the network may further know the approximate position of the UE according to the direction of the service beam as well as the time difference between reception and transmission Rx-Tx of the UE (UE Rx-Tx Time Difference) and other information. Then the network may roughly know the UE may detect which CSI-RS from which cells according to the approximate position of the UE and the beam direction of sending the CSI-RS of the neighboring cells. These information may help the UE detect the CSI-RS quickly, to thereby support the NR UE positioning.

Step 2: the terminal side measures the CSI-RSRP of the serving cell and/or neighboring cells according to the configuration information, and measures the TDOA between different cells.

According to the CSI-RS configuration information of the serving cell and neighboring cells, the UE may obtain the CSI-RSRP by detecting the CSI-RS.

The CSI-RS signal is transmitted at the preset time and frequency, and these preset parameters are known for the UE. Thus, when the UE performs the CSI-RS measurement, it may detect the Time of Arrival (TOA) of the CSI-RS signal. If the UE detects the CSI-RS signals of multiple cells, it may calculate the Time Difference of Arrival of CSI-RSs (CSI-TDOA) among these cells accordingly.

Step 3: the terminal reports the measurement result of the CSI-RSRP and/or CSI-TDOA and the corresponding cell identity and CSI-RS index.

The network side configures the terminal to report the measurement result of the CSI-RSRP and/or CSI-TDOA for positioning the NR terminal. The reported measurement result of the CSI-RSRP should be associated with the cell identity and CSI-RS index.

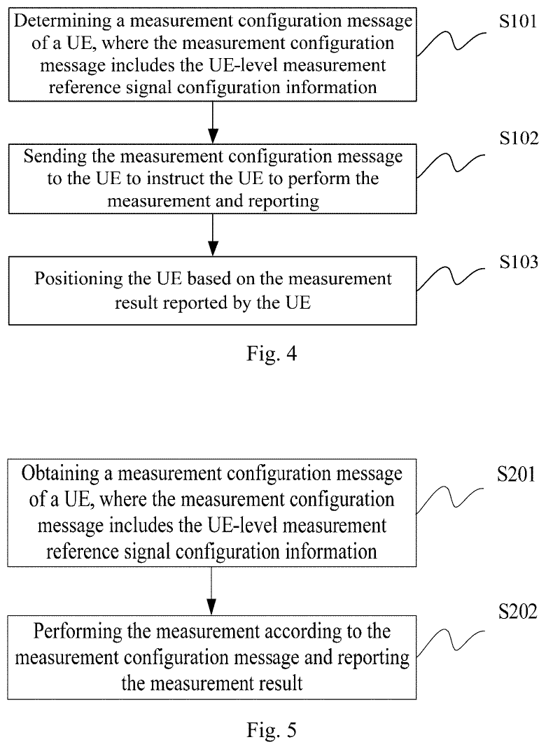

To sum up, referring to FIG. 4, at the network side, a positioning method provided by an embodiment of the present application includes:

S101: determining a measurement configuration message of a UE, where the measurement configuration message includes the UE-level measurement reference signal configuration information;

S102: sending the measurement configuration message to the UE to instruct the UE to perform the measurement and reporting;

S103: positioning the UE based on the measurement result reported by the UE.

Here, the step S103 may be understood as: a network-side device uses the received measurement result reported by the UE, and the UE is positioned directly by the network-side device; or may be understood as: a network-side device receives the measurement result reported by the UE and then sends it to another network-side device, and the UE is positioned by the another network-side device.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

Accordingly, referring to FIG. 5, at the UE side, a measurement reporting method provided by an embodiment of the present application includes:

S201: obtaining a measurement configuration message of a UE, where the measurement configuration message includes the UE-level measurement reference signal configuration information;

S202: performing the measurement according to the measurement configuration message and reporting the measurement result.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

The specific positioning flow will be illustrated below in combination with both the terminal and the network-side device.

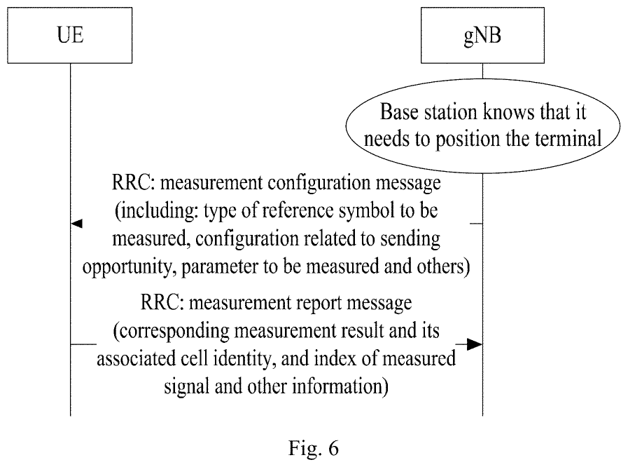

Referring to FIG. 6, when knowing that a terminal (UE) needs to be positioned, the network-side device (e.g., gNB) may send the configuration information of the above positioning signal to the terminal via the measurement configuration message in the process in the positioning protocol or RRC protocol, where the measurement configuration message specifically includes: the type of the signal that needs to be measured by the UE (PSS/SSS or CSI-RS or the like), relevant identification information thereof (e.g., CSI RS index, SS block set and the like), parameters to be measured (e.g., RSRP, TDOA and the like), the period of transmission, position, muting information of the reference signal, and others. The terminal measures the corresponding parameters for the configured reference signal according to the received measurement configuration information sent by the network, and reports the measurement result to the network.

Here, the gNB may know that it will position the terminal according to the positioning server or core network node, and the gNB configures that the information of the reference signal to be measured by the UE is sent to the terminal via the RRC signalling. The result measured by the terminal is reported to the gNB via the RRC message. The gNB may calculate the position information of the terminal by itself, or may forward the measurement result reported by the terminal to the external positioning server which calculates the position of the terminal.

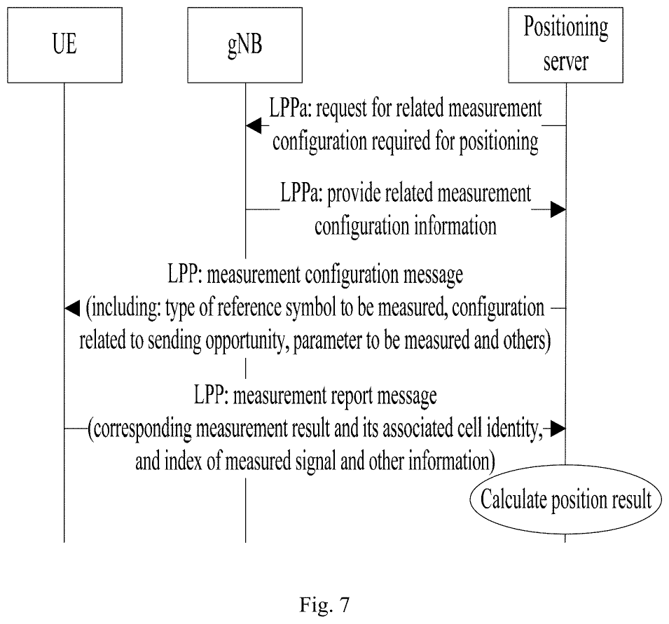

The positioning flow may be completed by a plurality of devices at the network side, for example, referring to FIG. 7, the positioning server sends a positioning request to the gNB to instruct the gNB to provide the relevant information on the measurement configuration. The gNB sends the measurement configuration information to the positioning server through the positioning auxiliary protocol similar to the LTE Positioning Protocol A (LPPa). The positioning server sends the measurement configuration information to the terminal through the positioning protocol between the positioning server and UE, e.g., the LTE Positioning Protocol (LPP). The terminal performs the corresponding positioning measurement according to the measurement configuration and reports the measurement result to the positioning server through the positioning protocol. Then the positioning server calculates the position of the terminal according to the measurement result reported by the UE.

The above illustration is described taking the LPP as an example. The development of the 5G positioning protocol may be based on the LTE Positioning Protocol (LPP) and LTE Positioning Protocol A (LPPa), or a new positioning protocol is defined for the NR.

Corresponding to the above-mentioned methods, the embodiments of the present application further provide the following apparatuses.

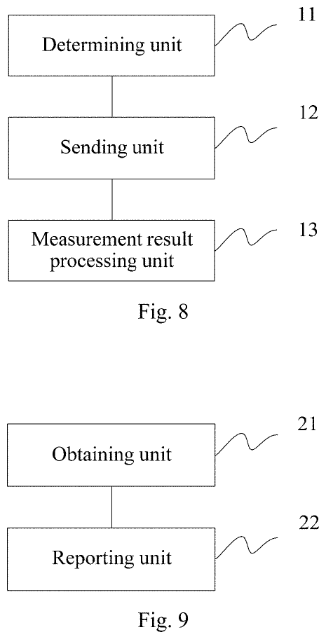

Referring to FIG. 8, at the network side, a positioning apparatus provided by an embodiment of the present application includes:

a determining unit 11 configured to determine a measurement configuration message of a UE, where the measurement configuration message includes the UE-level measurement reference signal configuration information;

a sending unit 12 configured to send the measurement configuration message to the UE to instruct the UE to perform measurement and reporting;

a measurement result processing unit 13 configured to position the UE based on the measurement result reported by the UE.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

Referring to FIG. 9, at the UE side, a measurement reporting apparatus provided by an embodiment of the present application includes:

an obtaining unit 21 configured to obtain a measurement configuration message of a UE, where the measurement configuration message includes the UE-level measurement reference signal configuration information;

a reporting unit 22 configured to perform the measurement according to the measurement configuration message and report the measurement result.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

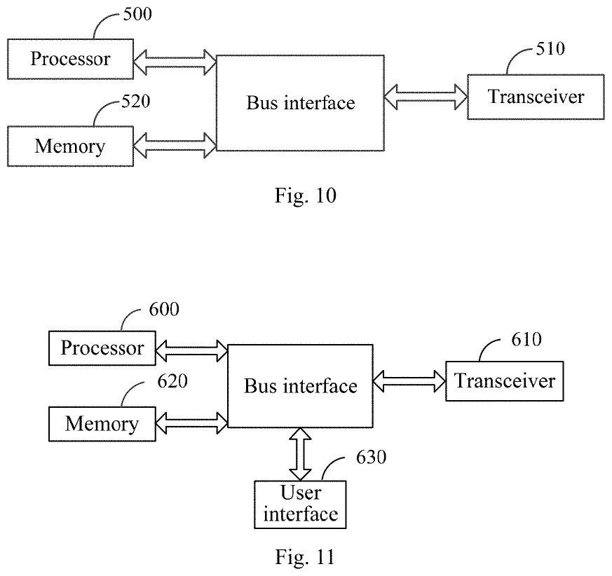

Referring to FIG. 10, at the network side, another positioning apparatus provided by an embodiment of the present application includes:

a processor 500 configured to read the programs in a memory 520 to perform the process of:
determining a measurement configuration message of a UE, where the measurement configuration message includes the UE-level measurement reference signal configuration information;
sending the measurement configuration message to the UE via a transceiver 510 to instruct the UE to perform the measurement and reporting;
positioning the UE based on the measurement result reported by the UE.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

The transceiver 510 is configured to receive and send the data under the control of the processor 500.

Here, in FIG. 10, the bus architecture can include any numbers of interconnected buses and bridges, and specifically link various circuits of one or more processors represented by the processor 500 and the memory(s) represented by the memory 520. The bus architecture can further link various other circuits such as peripheral device, voltage regulator and power management circuit, which are all well known in the art and thus will not be further described again herein. The bus interface provides an interface. The transceiver 510 can be a plurality of elements, i.e., include a transmitter and a receiver, and provide the units for communicating with various other devices over the transmission media. The processor 500 is responsible for managing the bus architecture and general processing, and the memory 520 can store the data used by the processor 500 when performing the operations.

The processor 500 can be Central Processing Unit (CPU), Application Specific Integrated Circuit (ASIC), Field-Programmable Gate Array (FPGA) or Complex Programmable Logic Device (CPLD).

Referring to FIG. 11, at the UE side, another measurement reporting apparatus provided by an embodiment of the present application includes:

a processor 600 configured to read the programs in a memory 620 to perform the process of:
obtaining a measurement configuration message of a UE, where the measurement configuration message includes the UE-level measurement reference signal configuration information;
performing the measurement according to the measurement configuration message and reporting the measurement result.

Optionally, the UE-level measurement reference signal configuration information specifically includes: Synchronization Signal block, SS block, configuration information.

Optionally, the SS block configuration information includes SS block configuration information of neighboring cells.

Optionally, the measurement result includes:

Reference Signal Received Power of SS Blocks, SS-RSRP, and/or Time Difference of Arrival of SS blocks, SS-TDOA.

Optionally, the measurement result further includes:

the cell identity and/or SS block time index, corresponding to the SS-RSRP.

Optionally, the UE-level measurement reference signal configuration information specifically includes: Channel State Information-Reference Signal, CSI-RS, configuration information.

Optionally, the measurement result includes one or a combination of:

Reference Signal Received Power of Channel State Information, CSI-RSRP, and CSI-RS index;

Time Difference of Arrival, TDOA, of CSI-RSs.

Optionally, the measurement configuration message and/or the measurement result is/are transmitted by a radio resource control protocol message or 5G positioning protocol message.

The transceiver 610 configured to receive and send the data under the control of the processor 600.

Here, in FIG. 11, the bus architecture can include any numbers of interconnected buses and bridges, and specifically link various circuits of one or more processors represented by the processor 600 and the memory represented by the memory 620. The bus architecture can further link various other circuits such as peripheral device, voltage regulator and power management circuit, which are all well known in the art and thus will not be further described again herein. The bus interface provides an interface. The transceiver 610 can be a plurality of elements, i.e., include a transmitter and a receiver, and provide the units for communicating with various other devices over the transmission media. For different user equipments, the user interface 630 can also be the interface capable of inter-connecting or exter-connecting with the required devices, and the connected devices include but not limited to keypad, display, loudspeaker, microphone, joystick and the like.

The processor 600 is responsible for managing the bus architecture and general processing, and the memory 620 can store the data used by the processor 600 when performing the operations.

Optionally, the processor 600 can be Central Processing Unit (CPU), Application Specific Integrated Circuit (ASIC), Field-Programmable Gate Array (FPGA) or Complex Programmable Logic Device (CPLD).

It should be understood by those skilled in the art that the embodiments of the invention can provide methods, systems and computer program products. Thus the invention can take the form of hardware embodiments alone, software embodiments alone, or embodiments combining the software and hardware aspects. Also the invention can take the form of computer program products implemented on one or more computer usable storage mediums (including but not limited to magnetic disk memories, CD-ROMs, optical memories and the like) containing computer usable program codes therein.

The invention is described by reference to the flow charts and/or the block diagrams of the methods, the devices (systems) and the computer program products according to the embodiments of the invention. It should be understood that each process and/or block in the flow charts and/or the block diagrams, and a combination of processes and/or blocks in the flow charts and/or the block diagrams can be implemented by the computer program instructions. These computer program instructions can be provided to a general-purpose computer, a dedicated computer, an embedded processor, or a processor of another programmable data processing device to produce a machine, so that an apparatus for implementing the functions specified in one or more processes of the flow charts and/or one or more blocks of the block diagrams is produced by the instructions executed by the computer or the processor of another programmable data processing device.

These computer program instructions can also be stored in a computer readable memory which is capable of guiding the computer or another programmable data processing device to operate in a particular way, so that the instructions stored in the computer readable memory produce a manufacture including the instruction apparatus which implements the functions specified in one or more processes of the flow charts and/or one or more blocks of the block diagrams.

These computer program instructions can also be loaded onto the computer or another programmable data processing device, so that a series of operation steps are performed on the computer or another programmable device to produce the computer-implemented processing. Thus the instructions executed on the computer or another programmable device provide steps for implementing the functions specified in one or more processes of the flow charts and/or one or more blocks of the block diagrams.

Although the preferred embodiments of the invention have been described, those skilled in the art can make additional alterations and modifications to these embodiments once they learn about the basic creative concepts. Thus the attached claims are intended to be interpreted to include the preferred embodiments as well as all the alterations and modifications falling within the scope of the invention.

Evidently those skilled in the art can make various modifications and variations to the embodiments of the invention without departing from the spirit and scope of the embodiments of the invention. Thus the invention is also intended to encompass these modifications and variations therein as long as these modifications and variations to the embodiments of the invention come into the scope of the claims of the invention and their equivalents.

1. A positioning method, comprising:
determining a measurement configuration message of a User Equipment, UE, wherein the measurement configuration message comprises UE-level measurement reference signal configuration information;
sending the measurement configuration message to the UE to instruct the UE to perform measurement and reporting;
positioning the UE based on a measurement result reported by the UE.

2. The method according to claim 1, wherein the UE-level measurement reference signal configuration information particularly comprises: Synchronization Signal block, SS block, configuration information.

3. The method according to claim 2, wherein the SS block configuration information comprises SS block configuration information of neighboring cells.

4. The method according to claim 2 or 3, wherein the measurement result comprises: Reference Signal Received Power of SS Blocks, SS-RSRP, and/or Time Difference of Arrival of SS blocks, SS-TDOA.

5. The method according to claim 4, wherein the measurement result further comprises:
a cell identity and/or an SS block time index, corresponding to the SS-RSRP.

6. The method according to claim 1, wherein the UE-level measurement reference signal configuration information particularly comprises: Channel State Information-Reference Signal, CSI-RS, configuration information.

7. The method according to claim 6, wherein the measurement result comprises one or a combination of:
Reference Signal Received Power of Channel State Information, CSI-RSRP, and CSI-RS index;
and
Time Difference of Arrival, TDOA, of CSI-RSs.

8. The method according to claim 1, wherein the measurement configuration message and/or the measurement result is/are transmitted by a radio resource control protocol message or a 5G positioning protocol message.

9. A measurement reporting method, comprising:
obtaining a measurement configuration message of a User Equipment, UE, wherein the measurement configuration message comprises UE-level measurement reference signal configuration information;
performing a measurement according to the measurement configuration message and reporting a measurement result.

10. The method according to claim 9, wherein the UE-level measurement reference signal configuration information particularly comprises: Synchronization Signal block, SS block, configuration information.

11. The method according to claim 10, wherein the SS block configuration information comprises SS block configuration information of neighboring cells.

12. The method according to claim 10 or 11, wherein the measurement result comprises:
Reference Signal Received Power of SS Blocks, SS-RSRP, and/or Time Difference of Arrival of SS blocks, SS-TDOA.

13. The method according to claim 12, wherein the measurement result further comprises:
a cell identity and/or an SS block time index, corresponding to the SS-RSRP.

14. The method according to claim 9, wherein the UE-level measurement reference signal configuration information particularly comprises: Channel State Information-Reference Signal, CSI-RS, configuration information.

15. The method according to claim 14, wherein the measurement result comprises one or a combination of:
Reference Signal Received Power of Channel State Information, CSI-RSRP, and CSI-RS index;
and
Time Difference of Arrival, TDOA, of CSI-RSs.

16. The method according to claim 9, wherein the measurement configuration message and/or the measurement result is/are transmitted by a radio resource control protocol message or a 5G positioning protocol message.

17-32. (canceled)

33. A positioning apparatus, comprising:
a processor configured to read programs in a memory to perform a process of:
determining a measurement configuration message of a User Equipment, UE, wherein the measurement configuration message comprises UE-level measurement reference signal configuration information;
sending the measurement configuration message to the UE via a transceiver to instruct the UE to perform measurement and reporting;
positioning the UE based on a measurement result reported by the UE;
the transceiver configured to receive and send data under control of the processor.

34. The apparatus according to claim 33, wherein the UE-level measurement reference signal configuration information particularly comprises: Synchronization Signal block, SS block, configuration information.

35-40. (canceled)

41. A measurement reporting apparatus, comprising:
a processor configured to read programs in a memory to perform a process of the method of claim 9.

42. The apparatus according to claim 41, wherein the UE-level measurement reference signal configuration information particularly comprises: Synchronization Signal block, SS block, configuration information.

43-48. (canceled)
